(19) United States
(12) Patent Application Publication
(10) Pub. No.: US 2026/0149181 A1
(43) Pub. Date: May 28, 2026

(54) Vehicle Roof Glass Antenna

(71) Applicant: Vitro Automotive Holdings Corporation, Cheswick, PA (US)

(72) Inventor: David Dai, Novi, MI (US)

(21) Appl. No.: 19/348,715

(22) Filed: Oct. 2, 2025

Related U.S. Application Data
(60) Provisional application No. 63/702,870, filed on Oct. 3, 2024.

(51) Int. Cl. H01Q 13/08; H01Q 1/32; H01Q 5/335

(52) U.S. Cl. CPC H01Q 13/08; H01Q 1/325; H01Q 5/335

(57) ABSTRACT

An antenna assembly may include: at least one transparent ply defining an outer perimeter; a transparent coating arranged on the transparent ply, the coating defining a peripheral edge arranged inwardly of the outer perimeter; at least one antenna feed layer arranged on the at least one transparent ply proximate to the peripheral edge and arranged a distance away from the transparent coating; and an unbalanced transmission line. The transparent ply, transparent coating, and antenna feed layer may be arranged in a window opening. The peripheral edge and an end of the window opening may define an antenna slot. The outer conductor and center conductor may be electrically connected to interfacing ends of the antenna slot. The at least one feed layer may be further arranged across the antenna slot from the end of the window opening.

### CROSS REFERENCE TO RELATED APPLICATIONS

This application claims priority to U.S. Provisional Application No. 63/702,870, filed Oct. 3, 2024, and titled Vehicle Roof Glass Antenna, the disclosure of which is hereby incorporated by reference in its entirety.

### BACKGROUND OF THE INVENTION

### Field of the Invention

The present disclosure relates to vehicle antennas and to antennas that are formed in connection with roof glazings having electrically conductive coatings.

### Description of Related Art

In recent years, increased demand for comfort, safety, and aesthetic features has resulted in several technical developments in automobiles, including panoramic sunroofs. They provide a more open and airy driving experience and allow for more sunlight and a wider view. A broad range of automobiles with panoramic sunroof features are being developed and sold by leading manufacturers. In order to reduce heat build-up in the interior of a vehicle, the panoramic roof glass may be coated with a solar control film that reflects solar energy. Such solar control films are usually transparent, electrically conductive films.

Historically, broadcasting antennas for vehicles consisted of structures which protruded from and were mounted to the outer surface of the body of the vehicle. Examples of this are the 31 in. long whip antenna mounted on the fender of a car and the shorter, mast-type antenna mounted on the roof of a car. However, these antennas present problems such as being easily damaged, having a lack of aesthetic appeal, creating aerodynamic drag and wind noise, and require holes to be formed through the vehicle body. All of these interfere with the design and the styling of the vehicle. Because of this, there is a desire to find other suitable areas on the vehicle to place antennas that do not interfere with its design and structure. One of those areas is the glass, such as the windshield and back window. This use can take advantage of the fact that glass typically makes a good dielectric substrate for an antenna. Now antennas for the reception and/or transmission of radio frequency waves such as AM, FM, TV, DAB, RKE, etc. are often mounted on or incorporated into the glass, particularly the transparent parts of the glass. These antennas can be formed by printing conductive lines such as silver or copper onto the transparent parts or by using metal wires or strips that are attached to the transparent parts.

For modern trucks and SUVs, roof mount mast antennas are still preferred because of the limitations of the back window structure. For example, SUVs usually have a smaller liftgate window and trucks often have three-piece back windows that are not suitable locations for antennas. For vehicles with a panoramic roof, the mast type antenna would lose the vehicle body as an antenna ground, and a roof mount antenna may not function well without a large ground plan. The current solution is to shorten the size of the glass roof to make room for mounting the antenna on sheet metal or make a cutout on glass edges to create a local ground plane for mounting an antenna. However, this complicates the glass fabrication process. Some prior constructions have integrated antennas with the window. Designs have been proposed that employ quarter or half wavelength antennas or slot antennas formed between the metal frame of a window and a conductive transparent film or coating. For example, U.S. Pat. Nos. 4,849,766, 4,768,037, 5,670,966 and 4,864,316 illustrate a variety of antenna shapes that are formed by a thin film on a vehicle window. U.S. Pat. Nos. 4,707,700, 5,355,144, 5,898,407, 7,764,239 B2, 9,337,525 B2, 10,811,760 B2, 10,847,867 B2, 10,923,795 B2 and 11,515,614 B2 disclose different slot antenna structures.

With rapid development of vehicle electronics, more and more antennas have been required for vehicles. At FM and TV frequencies in particular, vehicle systems require a number of antennas for diversity operation to overcome multipath and fading effects. In most cases as of today, AM, FM and TV antennas are integrated into back window glass for sedans and roof mount mast antenna for SUVs and trucks. With large roof glass, mast type antennas are no longer viable options for AM and FM antennas. Therefore, there is a need for alternative solutions for radio frequency antennas for trucks and SUVs with large glass roofs. Particularly, there is a need to eliminate mast type antennas that protrude from the vehicle body and replace them with antennas that can be integrated into the vehicle glass while meeting system performance requirements and retaining solar benefits of the heat reflective coating and pleasing aesthetics.

### SUMMARY OF THE INVENTION

In some embodiments or aspects, the present disclosure may be characterized by one or more of the following numbered clauses:

Clause 1. An antenna assembly configured to be used in a window, the antenna assembly comprising: at least one transparent ply defining an outer perimeter edge; a transparent coating arranged on the at least one transparent ply, the transparent coating defining a peripheral edge arranged inwardly of the outer perimeter edge; at least one antenna feed layer arranged on the at least one transparent ply, the transparent coating defining a peripheral edge arranged inwardly of the outer perimeter edge; at least one antenna feed layer arranged on the at least one transparent ply proximate to the peripheral edge and arranged a distance away from the transparent coating; and an unbalanced transmission line comprising an outer conductor and a center conductor, wherein the at least one transparent ply, the transparent coating, and the at least one antenna feed layer are arranged in a window opening, wherein the peripheral edge and an end of the window opening define an antenna slot, wherein the outer conductor and center conductor are electrically connected to interfacing ends of the antenna slot, and wherein the at least one antenna feed layer is further arranged across the antenna slot from the end of the window opening.

Clause 2. The antenna assembly of clause 1, wherein the at least one antenna feed layer is disposed on an exterior surface of the at least one transparent ply, wherein the at least one antenna feed layer has an area that interfaces the transparent coating such that a capacitance is created between the at least one antenna feed layer and the transparent coating, and wherein the impedance of the capacitance matches the impedance of the antenna slot to the impedance of the unbalanced transmission line.

Clause 3. The antenna assembly of clause 2, wherein the center conductor is electrically connected to the at least one antenna feed layer to capacitively couple the transparent coating to the unbalanced transmission line.

Clause 4. The antenna assembly of any of clauses 1-3, wherein the antenna slot is configured to have a plurality of modes, and wherein resonant frequencies of each of the plurality of modes are functions of a length of the antenna slot.

Clause 5. The antenna assembly of clause 4, wherein the window opening is at least partially defined by a frame, and wherein the transparent coating at least partially overlaps the frame at at least one location where an electrical field minimum of a resonant mode of the antenna slot is present.

Clause 6. The antenna assembly of clause 5, wherein the transparent coating at least partially overlaps the frame at a plurality of locations, thereby dividing the antenna slot into a plurality of antenna slots, wherein the plurality of antenna slots each have a length that is shorter than the length of the antenna slot, and wherein the plurality of antenna slots each have resonant frequencies that are higher than the resonant frequency of the antenna slot.

Clause 7. The antenna assembly of clause 6, wherein each of the plurality of antenna slots are configured to be used independently.

Clause 8. The antenna assembly of clause 7, wherein each of the plurality of slots are configured to be capacitively coupled to the unbalanced transmission line at a plurality of positions.

Clause 9. The antenna assembly of any of clauses 2-8, where the transparent coating comprises at least one deletion line extending transversely thereacross, and where the at least one deletion line divides the transparent coating into at least two transparent coating panels, thereby dividing the antenna slot into at least two antenna slots extending around the at least two transparent coating panels.

Clause 10. The antenna assembly of clause 9, wherein the at least one deletion line comprises one deletion line extending laterally across the transparent coating, thereby dividing the transparent coating into a front coating panel and a rear coating panel, wherein the at least one antenna feed layer comprises a plurality of antenna feed layers, wherein a first portion of the plurality of antenna feed layers interface with the front coating panel, and where a second portion of the plurality of antenna feed layers interface with the rear coating panel.

Clause 11. The antenna assembly of clause 9, wherein the at least one deletion line comprises a first deletion line and a second deletion line extending longitudinally across the transparent coating, thereby dividing the transparent coating into a top coating panel, a center coating panel, and a bottom coating panel, wherein the at least one antenna feed layer comprises a plurality of antenna feed layers, wherein a first portion of the plurality of antenna feed layers interface with the top coating panel, and wherein a second portion of the plurality of antenna feed layers interface with the bottom coating panel.

Clause 12. The antenna assembly of clause 11, wherein the top coating panel and the bottom coating panel are capacitively coupled to the center coating panel, and wherein a capacitance between the top coating panel and the center coating panel and a capacitance between the bottom coating panel and the center coating panel are functions of a coupling length and a separation distance between the respective panels.

Clause 13. The antenna assembly of clause 9, wherein the at least one deletion line comprises four deletion lines extending laterally across the transparent coating, thereby dividing the transparent coating into five coating panels.

Clause 14. The antenna assembly of clause 13, wherein the at least one antenna feed layer comprises four antenna feed layers, and wherein each of the four antenna feed layers extend from opposing ends of two of the five coating panels.

Clause 15. The antenna assembly of clause 13 or 14, wherein the at least one deletion line comprises a plurality of secondary deletion lines, and wherein the plurality of secondary deletion lines extend between adjacent deletion lines, thereby dividing at least a portion of the five coating panels into a plurality of subcoating panels.

Clause 16. A slot antenna comprising: a roof window arranged within a frame of a vehicle, the roof window comprising: an inner glass ply defining an outer perimeter; an outer glass ply; an interlayer disposed between the inner glass ply and the outer glass ply; and a transparent coating disposed between the interlayer and the outer glass ply, the transparent coating defining a peripheral edge; at least one antenna feed layer arranged on an inner glass ply proximate to the peripheral edge; and a coaxial cable comprising an outer conductor and a center conductor, wherein the peripheral edge and an end of the frame define a slot, wherein the outer conductor is electrically connected to the frame and the center conductor is electrically connected to the at least one antenna feed layer, thereby capacitively coupling the transparent coating to the coaxial cable, and wherein an impedance of a capacitance between the at least one antenna feed layer and the transparent coating matches the impedance of the antenna slot to the impedance of the coaxial cable.

Clause 17. The slot antenna of clause 16, wherein the inner glass ply comprises an inner surface and an outer surface, wherein the outer glass ply comprises an inner surface and an outer surface, wherein the transparent coating is disposed between the inner surface of the outer glass ply and the interlayer, and wherein the at least one antenna feed layer is disposed on the inner surface of the inner glass ply.

Clause 18. The slot antenna of clause 16 or 17, wherein the transparent coating at least partially overlaps the frame at a plurality of locations, thereby dividing the slot into a plurality of slots, and wherein the plurality of slots each have resonant frequencies that are higher than a resonant frequency of the slot.

Clause 19. The slot antenna of any of clauses 16-18, wherein the transparent coating comprises at least one deletion line extending transversely thereacross, and wherein the at least one deletion line divides the transparent coating into a plurality of transparent coating panels, thereby dividing the slot into a plurality of slots extending around the plurality of transparent coating panels.

Clause 20. The slot antenna of clause 19, wherein the at least one antenna feed layer comprises a plurality of antenna feed layers, and wherein at least one of the antenna feed layers interfaces with one of the plurality of transparent coating panels to capacitively couple the plurality of transparent coating panels to the coaxial cable.

### BRIEF DESCRIPTION OF THE DRAWING(S)

FIG. 1 is a perspective view of a vehicle having at least one antenna formed in its roof glass assembly, according to one non-limiting aspect or embodiment of the present disclosure;

FIG. 2A is a first cross-sectional view of the antenna and roof glass of FIG. 1 taken along line 2-2;

FIG. 2B is a second cross-sectional view of the antenna and roof glass of FIG. 1 taken along line 2-2;

FIG. 2C is a third cross-sectional view of the antenna and roof glass of FIG. 1 taken along line 2-2;

FIG. 3 is a first plan view of a transparent conductive coating of the roof glass assembly of FIG. 1, according to one non-limiting aspect or embodiment of the present disclosure;

FIG. 4A is a second plan view of a transparent conductive coating of the roof glass assembly of FIG. 1, according to one non-limiting aspect or embodiment of the present disclosure;

FIG. 4B is a plan view of an antenna feeding pad of the antenna as shown in circle 4B in FIG. 4A;

FIG. 4C is a plan view of a coating deletion line of the transparent conductive coating as shown in circle 4C in FIG. 4A;

FIG. 5A is a third plan view of a transparent conductive coating of the roof glass assembly of FIG. 1, according to one non-limiting aspect or embodiment of the present disclosure;

FIG. 5B is a plan view of a coating deletion zone of the transparent conductive coating as shown in circle 5B in FIG. 5A;

FIG. 6 is a fourth plan view of a transparent conductive coating of the roof glass assembly of FIG. 1, according to one non-limiting aspect or embodiment of the present disclosure;

FIG. 7 is a fifth plan view of a transparent conductive coating of the roof glass assembly of FIG. 1, according to one non-limiting aspect or embodiment of the present disclosure;

FIG. 8 is a sixth plan view of a transparent conductive coating of the roof glass assembly of FIG. 1, according to one non-limiting aspect or embodiment of the present disclosure;

FIG. 9 is a Smith chart illustrating the operation of the roof glass assembly in an FM frequency band, according to one non-limiting aspect or embodiment of the present disclosure;

FIG. 10 is a plot illustrating antenna performance of the roof glass assembly in horizontal polarization, according to one non-limiting aspect or embodiment of the present disclosure; and

FIG. 11 is a plot illustrating antenna performance of the roof glass assembly in vertical polarization, according to one non-limiting aspect or embodiment of the present disclosure.

### DESCRIPTION OF THE INVENTION

As used herein, the singular form of “a”, “an”, and “the” include plural referents unless the context clearly dictates otherwise.

The term “includes” is synonymous with “comprises”.

The term “at least” is synonymous with “greater than or equal to.” As used herein, “at least one of” is synonymous with “one or more of”. For example, the phrase “at least one of A, B, and C” means any one of A, B, or C, or any combination of any two or more of A, B, or C. For example, “at least one of A, B, and C” includes one or more of A alone; or one or more of B alone; or one or more of C alone; or one or more of A and one or more of B; or one or more of A and one or more of C; or one or more of B and one or more of C; or one or more of all of A, B, and C.

As used herein, the terms “perpendicular”, “parallel”, “substantially perpendicular”, or “substantially parallel” mean a relative angle as between two objects (if extended to theoretical intersection), such as elongated objects and including reference lines, that is from 0° to 5°, or from 0° to 3°, or from 0° to 2°, or from 0° to 1°, or from 0° to 0.5°, or from 0° to 0.25°, or from 0° to 0.1°, inclusive of the recited values.

The present disclosure uses directional language, such as forward, rearward, inward, outward, upward, downward, front, rear, etc. These directions describe relative positions around different features disclosed herein.

Some figures show many of the same elements. For clarity, not all of these elements are numbered.

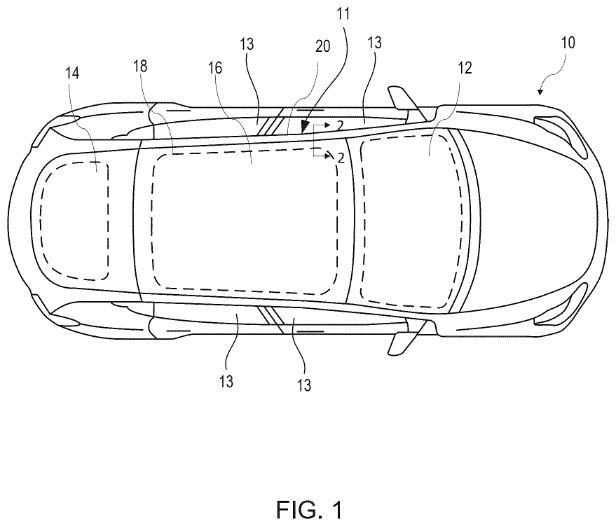

The present disclosure relates to antennas 11 used in glass, such as glass used in motor vehicles 10, an example of which is shown in FIG. 1. The antennas 11 are used to resonate at different bands to pick up and receive signals that can be used for AM, FM, digital audio broad cast (DAB), digital television (TV), broad band and other applications. While some or all of these signals and applications may be used in connection with a motor vehicle 10, the antennas 11 disclosed are not intended to be limited to use in motor vehicles 10 like the one shown. One will appreciate that the antennas 11 can be used with glass in other applications. For example, the antennas can be used with other vehicles or modes of transportation, such as trucks, busses, boats and airplanes. In other examples, the antennas 11 can be used in non-vehicular glass applications, such as on building windows or within smart glass or privacy glass used inside of buildings.

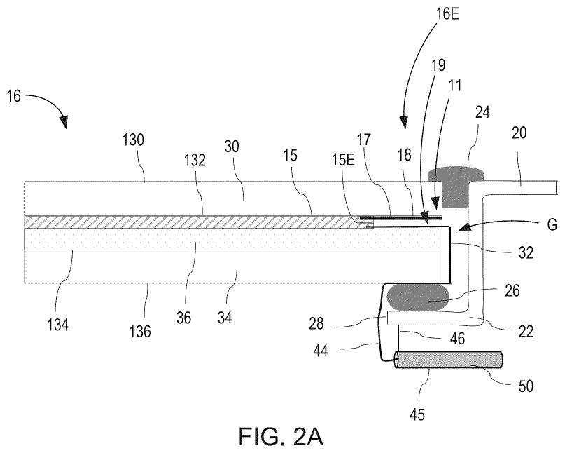

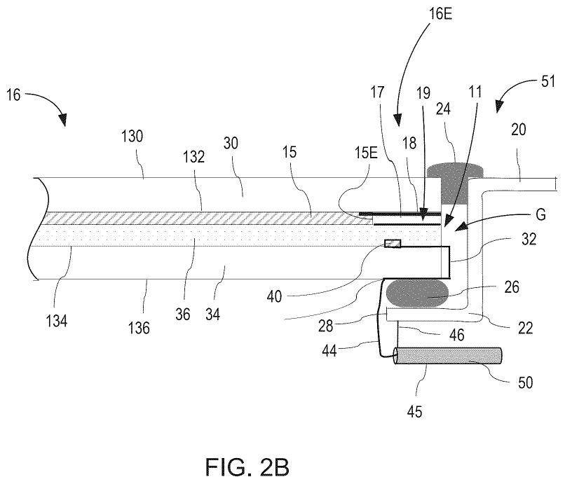

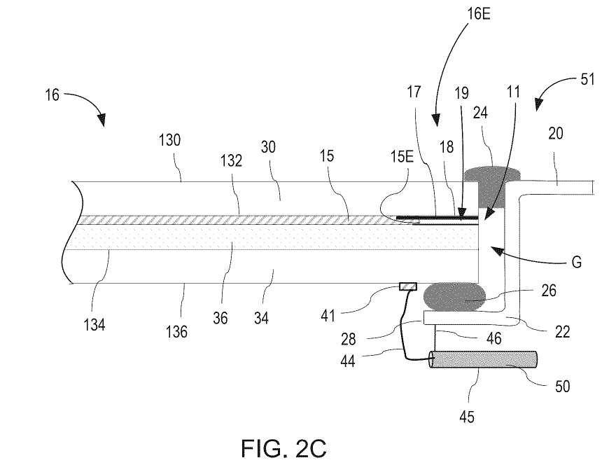

With reference to FIG. 1, a motor vehicle 10 (hereinafter the “vehicle”) having an antenna 11 according to one non-limiting aspect or embodiment of the present disclosure is shown. The vehicle 10 includes a windshield 12, back window 14, roof window 16, and passenger windows 13. The windshield 12, back window 14, roof window 16, and passenger windows 13 are typically made of glass. The windshield 12, back window 14, and roof window 16 include respective concealment bands 18 extending about a perimeter thereof. Generally, the concealment bands 18 may be applied by screen printing an opaque ink onto the glazing of the glass and firing the perimeter of the glass. The windshield 12, back window 14, and roof window 16 are held within a vehicle body 20, and are secured by metal frame portions of the body 20. The vehicle body 20 may be conductive to facilitate the operation of the antenna 11 and other elements on or within the vehicle 10. The vehicle body 20 extends generally horizontally and outward from the roof window 16 before generally extending downward to define the front, rear, and sides of the vehicle 10. The windshield 12 is located on a front portion of the vehicle 10, the back window 14 is located on a rear side, and the passenger windows 13 are arranged on respective sides of the vehicle body 20. Referring briefly to FIGS. 2A-2C, an outer edge 16E of the roof window 16 overlaps with an annual flange 22 of the body 20, which allows for the roof window 16 to be arranged relative to the body 20 with a gap G therebetween. The end of the annual flange 22 below the window 16 defines a window edge 28. A molding 24 is arranged between the outer edge 16E and primary portion of the vehicle body 20 to connect and at least partially secure the roof window 16 to the body. An annular sealing member 26 is arranged between the outer edge 16E and annular flange 22 and may be in the form of a glue bead 26.

Referring back to FIG. 1, the antenna 11 is arranged in the roof window 16. Although the antenna 11 is shown and described in connection with the roof window 16, one will appreciate that the antenna 11 can also be used in connection with the windshield 12, back window 14, and/or passenger windows 13. As will be described below, the antenna 11 is used in connection with the glass of the roof window 16. However, the antenna 11 may also be used in connection with a side glazing 13 in connection with the windshield 12 or in connection with a backlite in the back window 14.

Referring back to FIGS. 2A-2C, exemplary arrangements of the roof window 16 are shown. The roof window 16 is a laminated glazing that includes an outer transparent ply 30 and an inner transparent ply 34 that are both typically made of glass. The outer transparent ply 30 is bonded to the inner transparent ply 34 by an interlayer 36 that is typically made of polyvinyl butyral (PVB) or a similar material such as polyethylene terephthalate (PET). The outer transparent ply 30 has an outer surface 130 that defines the outside or outwardly facing surface of the roof window 16. The outer surface 130 may be referred to as the number one surface. The outer ply 30 also has an inner surface 132 that is arranged opposite the outer surface 130. The inner surface 132 may be referred to as the number two surface. The inner ply 34 has an outer surface 134 that is arranged across from the inner surface 132 of the outer ply 30. This outer surface 134 may be referred to as the number three surface. The inner ply 34 also has an inner surface 136 that is arranged opposite the inner surface 134. This inner surface 136 may be referred to as the number four surface. The inner surface 136 defines the inside or inwardly facing surface of the roof window 16 and faces internally to the passenger compartment of the vehicle 10. The interlayer 36 is arranged between the inner surface 132 of the outer ply 30 and the outer surface 134 of the inner ply 34.

Concealment bands 18 can be applied to the roof window around the perimeter of the inner surface 132 of the outer ply 30. The concealment band 18 may have a closed inner edge that defines the boundary of the daylight opening of the roof window 16. In other words, the concealment band defines the area of the roof window 16 that allows outside light into the vehicle and allows for passengers to view outside of the vehicle 10. As will be discussed below, the concealment band 18 may be sufficiently wide to cover elements of the antenna 11 as well as other features that are arranged proximate to the outer perimeter of the roof window 16.

The roof window 16 also includes a transparent coating 15 that is electroconductive and covers the daylight opening of the roof window 16. The transparent coating 15 is a coating that reflects incident infrared solar radiation. This reduces the transmission of infrared and ultraviolet radiation through the roof window 16 and essentially acts as a solar shield for the interior of the vehicle 10. The transparent coating 15 may be made of single or multiple layers of a metal-containing coating. Examples of these coatings 15 include those that have a sheet resistance in the range of 1Ω/□ to 3Ω/□ (ohms per square) and an optical transmission ranging between 70-76%, depending on the material used. In a specific example, the optical transmission may be 75%. As shown, the transparent coating 15 is arranged between the inner surface 132 of the outer ply 30 and the interlayer 36. This is done by applying the transparent coating 15 to the inner surface 132 or the interlayer 36. An end of the transparent coating 15 is also arranged proximate to the interlayer 36. The end of the transparent coating 15 and interlayer 36 are separated by a deletion line 17, which will be discussed below. The deletion line 17 defines a peripheral edge 15E in the transparent coating 15. Although this arrangement is shown, other arrangements of the transparent coating 15 may be used, such as between the outer surface 134 of the inner ply 34 and the interlayer 36.

The deletion line 17 is created by removing a band of the transparent coating 15 from the inner surface 132 of the outer ply 30. This is done by applying a metal mask, a chemical mask, or dissolving enamel to the transparent coating 15 or by using laser deletion techniques. Removal of the transparent coating 15 in these ways prevents corrosion of the remaining coating 15 and avoids undesired radio frequency coupling to the roof window 16 and frame 20. The deletion line 17 at least partially defines an antenna slot 19. The antenna slot 19 is fully arranged between the annular flange 22 and the peripheral edge 15E of the transparent coating 15. With this arrangement, the antenna slot 19 extends from the peripheral edge 15E, through the space between the interlayer 36 and outer ply 30 that is created by the deletion line 17 and across the gap G to the flange 22. The slot 19 extends downward into the gap G, in the direction of the glue bead 26. The presence of slot 19 means the antenna 11 may also be known as a slot antenna. The slot 19 may also be referred to as an antenna slot.

The width of the slot 19 between the peripheral edge 15E and flange 22 must be large enough that the capacitive effects across the slot 19 at the frequency of operation are negligible, so that the signal is not shorted out. This width may be 10 mm (0.40 in) or greater. The length of the slot 19 may vary. For annular slots 19, the length must be an integer multiple of the wavelength of the resonant frequency of the application. For the fundamental excitation mode, the length of the slot 19 is preferably equal to one wavelength of the resonant frequency. For higher excitation modes, the length is preferably equal to two or more wavelengths of the resonant frequency. For non-annular slots 19, the length must be an integer multiple of one half of the wavelength of the resonant frequency of the application.

FIG. 2A shows a first non-limiting example of an antenna 11 arranged relative to the roof window 16 and vehicle frame 20. The antenna 11 includes a copper foil 32 electrically connected to the transparent coating 15 at or proximate to the peripheral edge 15E. The copper foil 32 is laminated with the interlayer 36 between the outer ply 30 and inner ply 34. The copper foil 32 extends from the peripheral edge 15E along the deletion line 17 and slot 19 and is then folded around the edges of the interlayer 36 and inner glass ply 34 within the gap G. The copper foil 32 then extends along the inner surface 134. The copper foil 32 is secured to the inner surface 134 by the glue bead 26. As shown, the copper foil 32 is essentially sandwiched between the glue bead 26 and the inner surface 134. The copper foil 32 extends from the glue bead 26 and inner surface 134, so that an end of the foil 32 can be electrically connected to a center conductor 44 of a coaxial cable 50. A ground wire 46 extends between and electrically connects an outer conductor 45 of the coaxial cable 50 to the flange 22 at a location proximate to the edge 28. In this manner, the antenna 11 is directly fed by the coaxial cable 50. Energy applied by the coaxial cable 50 causes electrical current to flow on the transparent coating 15 and on the frame 20. The current(s) are not confined to only the edges of the slot 19 but instead spread out over the conductive coating 15 and frame 20. Antenna radiation then occurs from the electrical currents on the transparent coating 15 and on the frame 20. These connections mean the coaxial cable 50 is connected to interfacing ends of the antenna 11. In other embodiments, the copper foil 32 can be fed by other unbalanced transmission lines similar to the coaxial cable 50.

Plastic tape or a similar material can be used to cover some or all of the copper foil 32 to ensure that the copper foil 32 does not contact the vehicle frame 20, which would short out the radio frequency signals created by the antenna 11. For example, the portion of the copper foil 32 that extends within the gap G may be covered to prevent contact with the flange 22 that may occur overtime due to normal movement of the vehicle 10. The portion(s) of the copper foil 32 and/or center conductor 44 that are arranged proximate to the window edge 28 may also be covered.

FIG. 2B shows a second non-limiting example of an antenna 11 arranged relative to the roof window 16 and vehicle frame 20. This example of the antenna 11 involves capacitively connecting the center conductor 44 of the coaxial cable 50 to the transparent coating 15. This can be done by printing a conductive line 40 on the inner surface 134 of the inner ply 34 at which the center conductor 44 can be connected to the conductive line 40 by the copper foil 32. This results in a more robust connection to be formed with the central conductor 44 on the inner ply 34. In this example, conductive line 40 is separated from the transparent coating 15 by the interlayer 36. The conductive line 40 acts as an antenna feeding element and may be made of materials, such as copper tape, silver ceramic, or any other metal tape. With this understanding, the conductive line 40 may also be referred to as an antenna feed layer 40. The copper foil 32 is connected to the conductive line 40 and extends, so that it folds over the inner ply 34 to connect to the central conductor 44 along the inner surface 136. The copper foil 32 and/or central conductor 44 can be entirely or partially covered with plastic tape to prevent contact with the vehicle frame 20. In this embodiment, the coaxial cable 50, central conductor 44, and conductive line 40 are together known as an antenna feeding structure 51.

FIG. 2C shows a third non-limiting example of an antenna 11 arranged relative to the roof window 16 and vehicle frame 20. This antenna 11 includes a metal layer 41 that is bonded to the inner surface 136 of the inner ply 34. Moving forward, the metal layer 41 will be referred to as the antenna feed layer 41. The antenna feed layer 41 is separated from the transparent coating 15 by both the inner ply 34 and the interlayer 36. The antenna feed layer 41 is arranged on the inner surface 136, so that it overlaps a portion of the transparent coating 15 to form a capacitive coupling area. This creates an interface between the antenna feed layer and transparent coating 15. This obviates the need for a copper foil 32 that is used in the antennas 11 in FIGS. 2A and 2B. The central conductor 44 of the coaxial cable 50 is connected to the antenna feed layer 41 by an insulated wire or foil through soldering, a mating blade connector, or other conventional means. The part of the central conductor 44 that extends across from the edge 28 of the frame 20 may also be covered by plastic tape. The ground wire 46 remains connected to the frame 20 at or proximate to the edge 28 and connects to the outer conductor 45 of the coaxial cable 50, so that the coaxial cable 50 is connected to interfacing ends of the antenna 11.

The capacitive coupling between the antenna feed layer 41 and transparent coating 15, shown in the examples of FIG. 2C, allows for an easier manufacturing process of the roof window 16 and antenna 11. It also allows for easier tuning of the antenna 11 and impedance matching. The antenna feeding structure 51 provides an impedance transfer from coaxial cable 50 into the antennas 11 modes with its own impedance. The impedance of antenna feeding structure 51 is a function of feed position, frequency, and capacitive coupling area between antenna feed layer 41 and transparent coating 15. Only the modes of antenna 11 that are matched to the characteristic impedance of the coaxial cable 50 can be excited. Typically, the characteristic impedance is 50Ω. Comparing the direct feed shown in FIG. 2A and the capacitive coupling feed shown in FIG. 2C, the capacitive coupling allows for easier tuning for impedance matching because the antenna feed layer 41 is on the interior surface 136 of the inner ply 34.

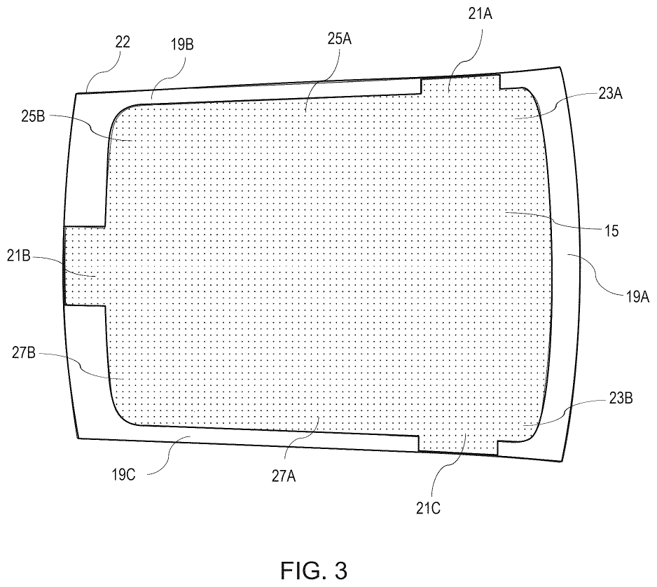

With the arrangements shown in FIGS. 2A-2C, the transparent coating 15 can be modified to result in one or more antennas 11 that have desired functionalities and characteristics to be used in a vehicle 10. Different examples of the modifications of the electro-conductive coating 15 will be described below in connection with FIGS. 3-8.

With reference to FIG. 3, a first example of a transparent coating 15 according to one non-limiting aspect or embodiment of the present disclosure is shown. The transparent coating 15 has a first slot 19A, second slot 19B, and third slot 19C that are at least partially formed by a first deletion line 17A, a second deletion line 17B, and a third deletion line 17C, respectively. This example of the transparent coating 15 may be used for vehicles 10 having large roof windows 16. This is because the resonant frequencies of antennas 11 are predominantly determined by the slot length which can be designed for antenna mode resonant frequencies that coincide with the operation frequencies of typical vehicle electronic systems. For vehicles 10 having large roof windows 16, the resonant frequencies of the antenna 11 may be too low for this purpose. To address this, the length of a single slot 19 can be shortened by providing a short 21 in the transparent coating 15. As shown, the transparent coating 15 includes a first short 21A, second short 21B, and third short 21C. Each of the shorts 21A, 21B, 21C overlap a portion of one or more edges 28 of the vehicle frame 20 (not shown in FIG. 3). Specifically, each of the shorts 21A, 21B, 21C overlap a portion of the window edge 28 at locations where the electrical field minimums of the resonant mode of the antenna 11 fare are located. This overlapping causes the radio frequency signals to short the vehicle frame 20 through the capacitive coupling. In this manner, antennas 11 in accordance with the present disclosure can be tuned to higher resonant frequencies to accommodate the system frequencies of the vehicle electronics.

As noted above, selective overlapping of the transparent coating 15 and the frame 20 by way of the three shorts 21A, 21B, 21C, separates a single annular slot 19 into the three slots 19A, 19B, 19C. This divides what was once a longer antenna 11 into multiple, smaller antennas along each of the slots 19A, 19B, 19C. These smaller antennas can be used independently. Each slot 19A, 19B, 19C has at least two feeds. The first slot 19A has a first feed 23A and a second feed 23B. The second slot 19B has a first feed 25A and a second feed 25B. The third slot 19C has a first feed 27A and a second feed 27B. For a large roof window 16, the length of each slot 19A, 19B, 19C is tuned to support two modes at their respective feeds 23A, 23B, 25A, 25B, 27A, 27B, essentially creating six antennas. The first mode is a TE10 mode, where the slot length is equal to half of the wavelength at FM frequencies. The second mode is a TE20 mode, where the slot length is equal to one wavelength at FM frequencies. The FM frequencies can range from 76 MHz to 108 MHz. The TE10 mode has a maximum electrical field in the middle of each slot 19A, 19B, 19C, while the TE20 mode has a minimum in the middle of each slot 19A, 19B, 19C. In this manner, feeding the antenna in the middle of each slot 19A, 19B, 19C only excites the TE10 mode. Using the first slot 19A as an example, if the feed is moved to a position one quarter wavelength from each end, such as to the first feed 23A and second feed 23B, then both the TE10 and TE20 modes are excited. Since the first and second feeds 23A, 23B are at least a quarter wavelength apart and weakly coupled, they may be used to provide a diversity of signals from the single slot 19A. The same is true for the second slot 19B and third slot 19C. Each slot 19A, 19B, 19C is separated from the other by at least half of a wavelength. Because each slot 19A, 19B, 19C is also located at different locations on the roof window 16, this allows all six antennas to be used simultaneously to provide greater diversity of signals to the vehicle 10.

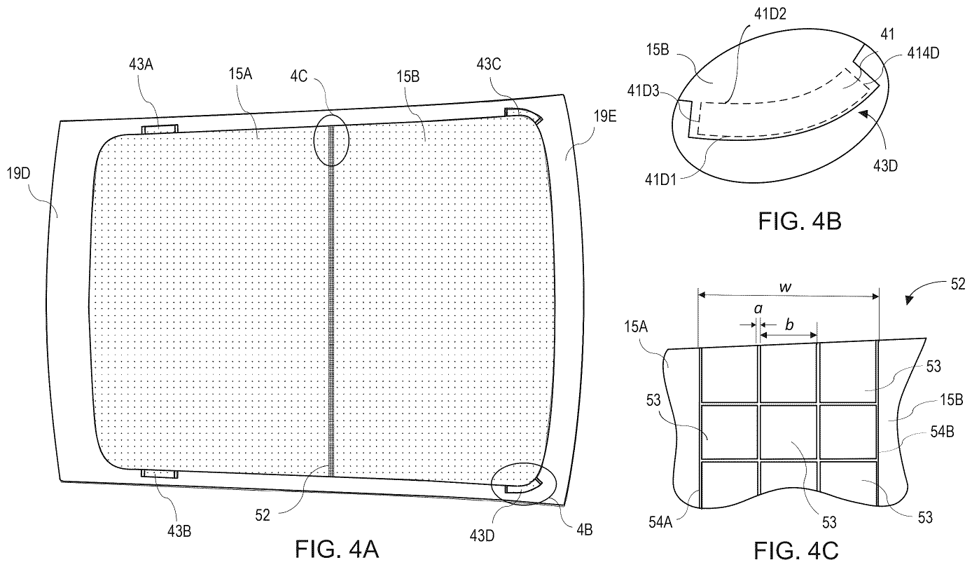

With reference to FIGS. 4A-4C, a second example of a transparent coating 15 according to one non-limiting aspect or embodiment of the present disclosure is shown. As shown in FIG. 4A, the transparent coating 15 is divided into a front coating panel 15A and a rear coating panel 15B by a deletion line 52 extending laterally across the coating 15. The deletion line 52 is a space where no transparent coating 15 is present and may be formed similar to the deletion lines 17 discussed above or by applying a metal template or chemical mask to the roof window 16 prior to the coating process. As shown, the deletion line 52 extends across a central portion of the transparent coating 15, so that the front coating panel 15A and rear coating panel 15B are the same or of similar size. However, the deletion line 52 may extend across any part of transparent coating 15 to vary the relative sizes of the front coating panel 15A and rear coating panel 15B.

The presence of the deletion line 52 creates a first slot 19D and a second slot 19E relative to the front coating panel 15A and the rear coating panel 15B. As shown, the first slot 19D is formed around the perimeter of the front coating panel 15A, and the second slot 19E is formed around the perimeter of the second coating panel 15B. This means that the first slot 19D is formed around the edge of the front coating panel 15A, extending to both the annual flange 22 of the frame 20 and the rear coating panel 15B. The second slot 19E is formed around the edge of the rear coating panel 15B, extending to both the annual flange 22 and the front coating panel 15A. With this arrangement, the resonant frequency of the modes of the slots 19D, 19E may be tuned higher than the slot 19 in embodiments that do not include the deletion line 52. This is due to the reduced total slot length. The relative sizes of the front coating panel 15A and second coating panel 15B can be modified to allow for further tuning of the resonant frequencies.

To capacitively connect the antennas 11 using the slots 19D, 19E, antenna feeding pads 43A, 43B, 43C, 43D are arranged between the front coating panel 15A, rear coating panel 15B, and the antenna feed layer 41. The antenna feeding pads 43A, 43B, 43C, 43D are areas where portions of the front coating panel 15A or rear coating panel 15B overlap or interface with one or more antenna feed layers 41 arranged on the inner ply 34. As shown, the front coating panel 15A is provided with a first antenna feeding pad 43A and a second antenna feeding pad 43B. The rear coating panel 15B is provided with a third antenna feeding pad 43C and a fourth antenna feeding pad 43D. Each of the antenna feeding pads 43A, 43B, 43C, 43D are areas where one of the antenna feed layers 41 of the antenna feeding structure 51 is bonded to the interior surface 136 of inner glass ply 34 and interfaces with the transparent layer 15. At these locations, portions of the transparent coating panels 15A, 15B extend outward to overlap or interface with the antenna feed layers 41. This creates a capacitive coupling between the antenna feed layers 41 and the transparent coating panels 15A, 15B. FIG. 4B shows an example of one arrangement of an antenna feeding pad 43D. The antenna feed layer 41D is shown in dotted lines to indicate that it is arranged under the transparent coating 15B. As previously noted, the antenna feed layer 41 is further separated from the transparent coating 15B by the inner glass ply 34 and interlayer 36 even though these elements are not shown in FIG. 4B. The antenna feed layer 41 can be sized in different ways to achieve a desired functionality of the antenna(s) 11. As shown, the antenna feed layer 41D has a quadrilateral cross-section defined by curved longitudinal sides 41D1, 41D2 and straight lateral sides 41D3. In one example, the longitudinal sides 41D1, 41D2 have an average length of 105 mm (4.13 in), and the lateral sides 41D3 have a width of 20 mm (0.79 in). Given the curved shape of the longitudinal sides 41D1, 41D2 one will appreciate that the outer side 41D1 will have a longer arc length than the inner side 41D2. For antenna feeding pads 43A, 43B that are not curved in shape, the antenna feed layer 41 may have a substantially rectangular cross-sectional shape, with the lengths of the longitudinal sides both equaling 105 mm. In other words, the antenna feed layers 41 of antenna feeding pads 43A, 43B may be similar to the antenna feed layer 41D of FIG. 4B, but they will have straight longitudinal sides. As shown, the transparent coating 15B may be sized to entirely cover the antenna feed layer 41 in the area of the antenna feeding pad 43D. However, the transparent coating 15B may have a small cross-sectional area, so that part of the antenna feed layer 41 does not overlap the transparent coating 15B. The examples of the antenna feeding pads described below may have the same or similar arrangements to antenna feeding pads 43A, 43B, 43C, 43D.

The arrangement shown in FIG. 4A may decrease the protective solar and thermal properties of the transparent coating 15 and create noticeable color differences between the coating 15 and the non-coated portions, such as the deletion line 52. To account for this, the transparent coating 15 in FIG. 4A may utilize a frequency selective surface (FSS). The FSS may also provide RF compatibility proximate to the deletion line 52. With reference to FIG. 4C, this may be achieved by providing an array of metallic patches 53 (not all numbered for clarity) within the deletion line 52 and between opposing ends 54A, 54B of the deletion line 52. The metallic patches may transmit or reflect electromagnetic fields based on the frequency of the field present within the deletion line 52. The metallic patches 53 may be formed in the deletion line 52 by a pulsed laser, chemical masking, or a coating dissolving enamel that provides a pattern of non-conductive lines. In other examples, this may be achieved by providing a conducting sheet that is perforated with apertures.

As shown, the total width w of the deletion line 52 may be greater than or equal to 10 mm (0.40 in). The width b of each metallic patch 53 can be adjusted depending on the frequency usage of the slots 19D, 19E. For example, the width b may be 5 mm (0.20 in) for RF signals frequency of up to 200 MHz, 3 mm (0.12 in) for RF signals up to 1 GHz, and 1 mm (0.04 in) for RF signals greater than 1 GHz. The width a of the deletion line 52 between respective patches 53 is preferred to be around 0.1 mm and can be adjusted based on the sizes of the total width w and the width(s) b of the patches 53. As an example, metallic patches 53 having a 5 mm width b and a 0.1 mm deletion line width a, only approximately 4% of the space within the deletion line 52 is uncovered by a metallic patch 53. This preserves the solar properties of the transparent coating 15 that would otherwise be absent if the metallic patches were not present.

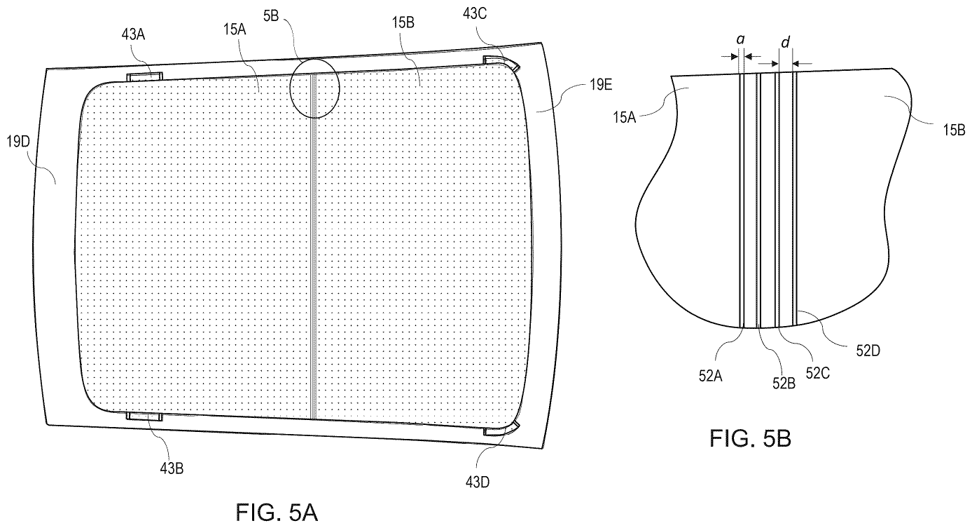

With reference to FIGS. 5A and 5B, a second example of a transparent coating 15 according to one non-limiting aspect or embodiment of the present disclosure is shown. This transparent coating 15 is similar to the transparent coating 15 shown in FIG. 4A and includes a front coating panel 15A, a rear coating panel 15B, a first slot 19D, a second slot 19E, and four antenna feeding pads 43A, 43B, 43C, 43D. However, the front coating panel 15A is separated from the rear coating panel 15B by four deletion lines 52A, 52B, 52C, 52D, which are shown in FIG. 5B. As shown, the deletion lines 52A, 52B, 52C, 52D extend substantially parallel to one another. Each deletion line 52A, 52B, 52C, 52D is separated by a distance d of 5 mm, which is used for FM frequencies. Each deletion line 52A, 52B, 52C, 52D has a width a of approximately 0.1 mm (0.004 in). These dimensions can be varied depending on the desired frequencies or application(s) of the antenna 11 using the transparent coating 15.

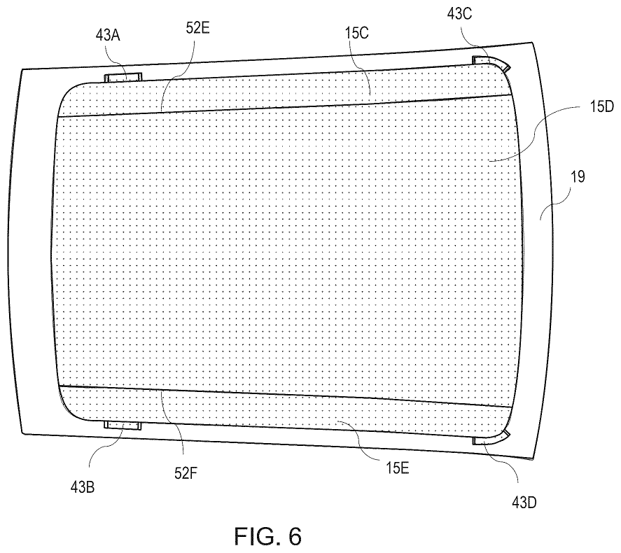

With reference to FIG. 6A, a third example of a transparent coating 15 according to one non-limiting aspect or embodiment of the present disclosure is shown. The transparent coating 15 is divided into a top coating panel 15C, a center coating panel 15D, and a bottom coating panel 15E by two deletion lines 52E, 52F. The deletion lines 52E, 52F extend longitudinally along the coating 15. As shown, the first deletion line 52E divides the coating 15 between the top coating panel 15C and center coating panel 15D, and the second deletion line 52F divides the coating 15 between the center coating panel 15D and the bottom coating panel 15E. The deletion lines 52E, 52F can be sized, so that they are essentially invisible to the naked eye. An example of this sizing is approximately 0.1 mm, but the deletion lines 52E, 52F may be smaller or larger, so long as they are minimally noticeable to passengers of the vehicle 10. The transparent coating 15 also includes antenna feeding pads 43A, 43B, 43C, 43D that are arranged similar to the examples described above.

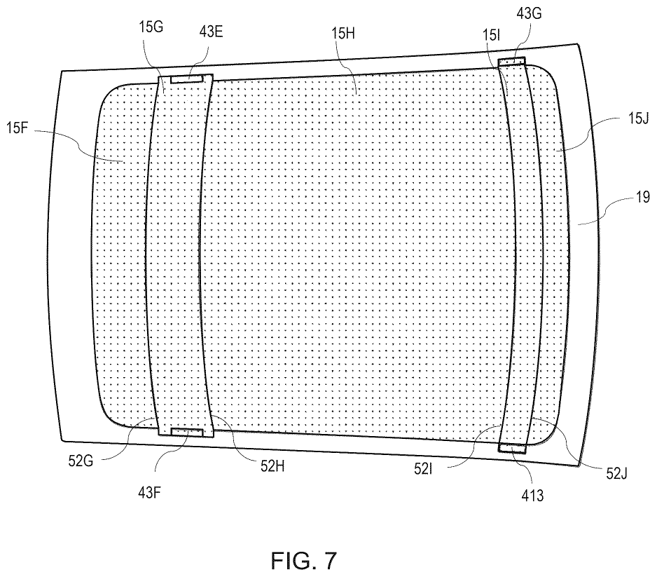

With reference to FIG. 7, a fourth example of a transparent coating 15 according to one non-limiting aspect or embodiment of the present disclosure is shown. The transparent coating 15 is divided into five coating panels 15F, 15G, 15H, 15I, 15J by four deletion lines 52G, 52H, 52I, 52J. As shown, the deletion lines 52G, 52H, 52I, 52J generally extend laterally across the coating 15. However, the deletion lines 52G, 52H, 52I, 52J have a slightly curved shape, so that the first deletion line 52G extends substantially parallel to the second deletion line 52H, and the third deletion line 52C extends substantially parallel to the fourth deletion line 52D.

The first deletion line 52G extends across the coating 15 and divides the coating 15 between the first coating panel 15F and the second coating panel 15G. The second deletion line 52H divides the coating 15 between the second coating panel 15G and the third coating panel 15H. The third deletion line 52I divides the coating 15 between the third coating panel 15H and fourth coating panel 15I. The fourth deletion line 52J divides the coating 15 between the fourth coating panel 15I and the fifth coating panel 15J. As shown, the third coating panel 15H occupies the largest amount of space of the entire coating 15. The second coating panel 15G and fourth coating panel 15I can be thought of as strips that are contained by their respective deletion lines 52G, 52H, 52I, 52J. Antenna feeding pads 43E, 43F, 43G, 43H are arranged at ends of the second and fourth coating panels 15G, 15I. First and second antenna feeding pads 43E, 43F are arranged at opposing ends of the second coating panel 15G, and third and fourth antenna feeding pads 43G, 43H are arranged at opposing ends of the fourth coating panel 15I. With this arrangement, the second coating panel 15G is capacitively coupled to the first and third coating panels 15F, 15H, and the fourth coating panel 15I is capacitively coupled to the third and fifth coating panels 15H, 15J.

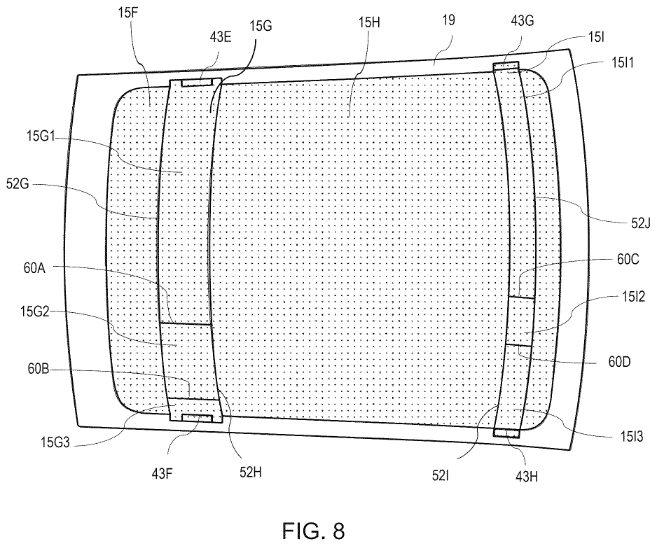

With reference to FIG. 8, a fifth example of a transparent coating 15 according to one non-limiting aspect or embodiment of the present disclosure is shown. This transparent coating 15 is similar to the one shown in FIG. 7, including five coating panels 15F, 15G, 15H, 15I, 15J divided by four deletion lines 52G, 52H, 52I, 52J and having four antenna feeding pads 43E, 43F, 43G, 43H arranged at respective ends of the second and fourth coating panels 15G, 15I. However, the second coating panel 15G and the fourth coating panel 15I are further divided into subcoating panels 15G1, 15G2, 15G3, 15I1, 15I2, 15I3 by secondary deletion lines 60A, 60B, 60C, 60D. The secondary deletion lines 60A, 60B, 60C, 60D extend longitudinally across either the second coating panel 15G or the fourth coating panel 15I. As shown, the first secondary deletion line 60A extends along and divides the second coating panel 15G between the first subcoating panel 15G1 and the second subcoating panel 15G2. The second secondary deletion line 60B divides the second coating panel 15G between the second subcoating panel 15G2 and the third subcoating panel 15G3. The third secondary deletion line 60C extends along and divides the fourth coating panel 15I between the fourth subcoating panel 15I1 and the fifth subcoating panel 15I2. The fourth secondary deletion line 60D divides the fourth coating panel 15I between the fifth subcoating panel 15I2 and the sixth subcoating panel 15I3. The first secondary deletion line 60A extends substantially parallel to the second secondary deletion line 60B, and the third secondary deletion line 60C extends substantially parallel to the fourth secondary deletion line 60D.

As shown, the antenna feeding pads 43E, 43F, 43G, 43H are arranged at opposing ends of the second coating panel 15G and fourth coating panel 15I. Specifically, the first antenna feeding pad 43E is arranged at an end of the first subcoating panel 15G1, and the fourth antenna feeding pad 43F is arranged at an end of the third subcoating panel 15G3 opposite the first antenna feeding pad 43E. The second antenna feeding pad 43G is arranged at an end of the fourth subcoating panel 15I1, and the third antenna feeding pad 43H is arranged at an end of the sixth subcoating panel 15I3 opposite the second antenna feeding pad 43G. This arrangement results in a capacitive coupling between adjacent coating panels. This means, for example, that the first subcoating panel 15G1 is capacitively coupled to the first coating panel 15F, the second subcoating panel 15G2, and the third coating panel 15H. The relative arrangements between and sizes of each of the aforementioned coating panels, subcoating panels, deletion lines, and secondary deletion lines can be modified to adjust the tuning of the antenna(s) 11 and impedance matching as described above.

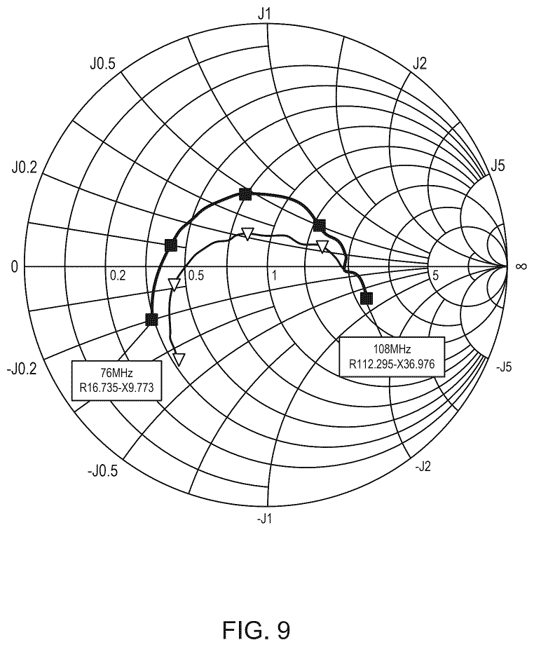

Referring back to FIG. 6, a vehicle 10 was tested using the transparent coating shown having coating panels 15C, 15D, 15E, deletion lines 52E, 52F, and antenna feeding pads 43A, 43B, 43C, 43D. The antenna feeding pads 43A, 43B, 43C, 43D include antenna feed layers 41 that are sized the same as those discussed in connection with FIG. 4. In other words, the antenna feed layers 41 have a length of 105 mm and a width of 20 mm. The top coating panel 15C and the bottom coating panel 15E have widths of approximately 100 mm (3.94 in). The testing resulted in the Smith chart shown in FIG. 9.

With reference to FIG. 9, the Smith chart shows the plots of two curves, one represented with squares (the “square curve”) and the other represented with triangles (the “triangle curve”). The square curve illustrates an antenna 11 where the transparent coating 15 does not have deletion lines 52E, 52F. The triangle curve illustrates an antenna 11 with a transparent coating 15 shown in FIG. 6 having deletion lines 52E, 52F. Both antennas 11 were fed by the antenna feeding pad 43D over the FM band normalized to 50 Ohms. The start frequency was 76 MHz, and the stop frequency was 108 MHz. In the case of the antenna 11 represented by the square curve, the plot illustrates the inductive nature of the reactive component of the antenna impedance. In the case of the antenna 11 represented by the triangle curve, the plot illustrates a more resistive impedance and a voltage standing wave ratio less than 2:1. With this, the presence of the deletion lines 52E, 52F has been found to afford an opportunity for impedance matching the antenna 11 to the transmission line (i.e., the coaxial cable 50 shown in FIG. 2C). The antenna 11 with the deletion lines 52E, 52F was also found to have a reactive component which is inductive because the capacitance between the bottom coating panel 15E and center coating panel 15D and the capacitance between the center coating panel 15D and top coating panel 15C is a function of their respective coupling lengths. Consequently, the distance between the coating panels 15C, 15D, 15E, and the dielectric constant of the roof window 16 material, which can be selected to match the antenna 11 to the transmission line and thus minimize the net reactive component seen by the transmission line and thereby maximize RF energy transfer.

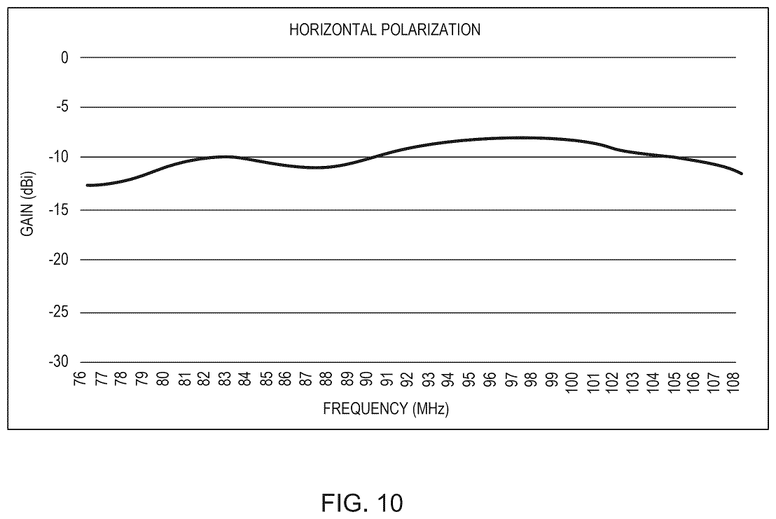

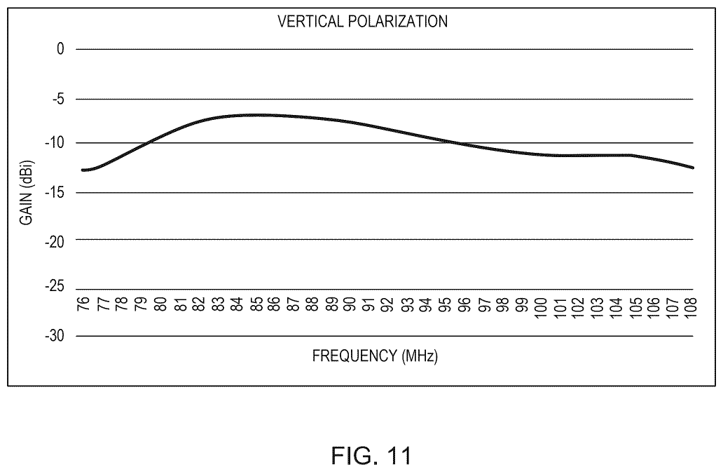

With reference to FIGS. 10 and 11, charts illustrating the gain performance of the antenna 11 having the transparent coating 15 shown in FIG. 6 are shown. The antenna 11 performance shown in both FIGS. 10 and 11 were measured on a vehicle in a VHF antenna range. FIGS. 10 and 11 measure the performance in decibels relative to isotropic (dBi). FIG. 10 shows the average gain plot of the antenna feeding pad 43D over a frequency range of 76-108 MHz where horizontal polarization is utilized. Here, the roof assembly 16 having antenna 11 exhibited average gains greater than −12 dBi throughout the given frequency range. FIG. 11 shows the average gain plot of the antenna feeding pad 43D over a frequency range of 76-108 MHz where vertical polarization is utilized. Here, the roof assembly 16 having antenna 11 also exhibited average gains greater than −12 dBi throughout the given frequency range. As can be seen in FIGS. 10 and 11, the exhibited gains are substantially across the entire frequency range.

While specific embodiments of the devices of the present disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the device of the present disclosure which is to be given the full breadth of the claims appended and any and all equivalents thereof.

1. An antenna assembly configured to be used in a window, the antenna assembly comprising:
at least one transparent ply defining an outer perimeter edge;
a transparent coating arranged on the at least one transparent ply, the transparent coating defining a peripheral edge arranged inwardly of the outer perimeter edge;
at least one antenna feed layer arranged on the at least one transparent ply proximate to the peripheral edge and arranged a distance away from the transparent coating; and
an unbalanced transmission line comprising an outer conductor and a center conductor,
wherein the at least one transparent ply, the transparent coating, and the at least one antenna feed layer are arranged in a window opening,
wherein the peripheral edge and an end of the window opening define an antenna slot,
wherein the outer conductor and center conductor are electrically connected to interfacing ends of the antenna slot, and
wherein the at least one antenna feed layer is further arranged across the antenna slot from the end of the window opening.

2. The antenna assembly of claim 1, wherein the at least one antenna feed layer is disposed on an exterior surface of the at least one transparent ply,
wherein the at least one antenna feed layer has an area that interfaces the transparent coating such that a capacitance is created between the at least one antenna feed layer and the transparent coating, and
wherein the impedance of the capacitance matches the impedance of the antenna slot to the impedance of the unbalanced transmission line.

3. The antenna assembly of claim 2, wherein the center conductor is electrically connected to the at least one antenna feed layer to capacitively couple the transparent coating to the unbalanced transmission line.

4. The antenna assembly of claim 1, wherein the antenna slot is configured to have a plurality of modes, and
wherein resonant frequencies of each of the plurality of modes are functions of a length of the antenna slot.

5. The antenna assembly of claim 4, wherein the window opening is at least partially defined by a frame, and
wherein the transparent coating at least partially overlaps the frame at at least one location where an electrical field minimum of a resonant mode of the antenna slot is present.

6. The antenna assembly of claim 5, wherein the transparent coating at least partially overlaps the frame at a plurality of locations, thereby dividing the antenna slot into a plurality of antenna slots,
wherein the plurality of antenna slots each have a length that is shorter than the length of the antenna slot, and
wherein the plurality of antenna slots each have resonant frequencies that are higher than the resonant frequency of the antenna slot.

7. The antenna assembly of claim 6, wherein each of the plurality of antenna slots are configured to be used independently.

8. The antenna assembly of claim 7, wherein each of the plurality of slots are configured to be capacitively coupled to the unbalanced transmission line at a plurality of positions.

9. The antenna assembly of claim 2, wherein the transparent coating comprises at least one deletion line extending transversely thereacross, and
wherein the at least one deletion line divides the transparent coating into at least two transparent coating panels, thereby dividing the antenna slot into at least two antenna slots extending around the at least two transparent coating panels.

10. The antenna assembly of claim 9, wherein the at least one deletion line comprises one deletion line extending laterally across the transparent coating, thereby dividing the transparent coating into a front coating panel and a rear coating panel,
wherein the at least one antenna feed layer comprises a plurality of antenna feed layers,
wherein a first portion of the plurality of antenna feed layers interface with the front coating panel, and
wherein a second portion of the plurality of antenna feed layers interface with the rear coating panel.

11. The antenna assembly of claim 9, wherein the at least one deletion line comprises a first deletion line and second deletion line extending longitudinally across the transparent coating, thereby dividing the transparent coating into a top coating panel, a center coating panel, and a bottom coating panel,
wherein the at least one antenna feed layer comprises a plurality of antenna feed layers,
wherein a first portion of the plurality of antenna feed layers interface with the top coating panel, and
wherein a second portion of the plurality of antenna feed layers interface with the bottom coating panel.

12. The antenna assembly of claim 11, wherein the top coating panel and the bottom coating panel are capacitively coupled to the center coating panel, and
wherein a capacitance between the top coating panel and the center coating panel and a capacitance between the bottom coating panel and the center coating panel are functions of a coupling length and a separation distance between the respective panels.

13. The antenna assembly of claim 9, wherein the at least one deletion line comprises four deletion lines extending laterally across the transparent coating, thereby dividing the transparent coating into five coating panels.

14. The antenna assembly of claim 13, wherein the at least one antenna feed layer comprises four antenna feed layers, and
wherein each of the four antenna feed layers extend from opposing ends of two of the five coating panels.

15. The antenna assembly of claim 13, wherein the at least one deletion line comprises a plurality of secondary deletion lines,
wherein the plurality of secondary deletion lines extend between adjacent deletion lines, thereby dividing at least a portion of the five coating panels into a plurality of subcoating panels.

16. A slot antenna comprising:
a roof window arranged within a frame of a vehicle, the roof window comprising:
an inner glass ply defining an outer perimeter;
an outer glass ply;
an interlayer disposed between the inner glass ply and the outer glass ply; and
a transparent coating disposed between the interlayer and the outer glass ply, the transparent coating defining a peripheral edge;
at least one antenna feed layer arranged on the inner glass ply proximate to the peripheral edge; and
a coaxial cable comprising an outer conductor and a center conductor,
wherein the peripheral edge and an end of the frame define a slot,
wherein the outer conductor is electrically connected to the frame and the center conductor is electrically connected to the at least one antenna feed layer, thereby capacitively coupling the transparent coating to the coaxial cable, and
wherein an impedance of a capacitance between the at least one antenna feed layer and the transparent coating matches the impedance of the antenna slot to the impedance of the coaxial cable.

17. The slot antenna of claim 16, wherein the inner glass ply comprises an inner surface and an outer surface,
wherein the outer glass ply comprises an inner surface and an outer surface,
wherein the transparent coating is disposed between the inner surface of the outer glass ply and the interlayer, and
wherein the at least one antenna feed layer is disposed on the inner surface of the inner glass ply.

18. The slot antenna of claim 16, wherein the transparent coating at least partially overlaps the frame at a plurality of locations, thereby dividing the slot into a plurality of slots, and
wherein the plurality of slots each have resonant frequencies that are higher than a resonant frequency of the slot.

19. The slot antenna of claim 16, wherein the transparent coating comprises at least one deletion line extending transversely thereacross, and
wherein the at least one deletion line divides the transparent coating into a plurality of transparent coating panels, thereby dividing the slot into a plurality of slots extending around the plurality of transparent coating panels.

20. The slot antenna of claim 19, wherein the at least one antenna feed layer comprises a plurality of antenna feed layers, and
wherein at least one of the plurality of antenna feed layers interfaces with one of the plurality of transparent coating panels to capacitively couple the plurality of transparent coating panels to the coaxial cable.
